(19) United States
(12) Patent Application Publication
(10) Pub. No.: US 2021/0309015 A1
(43) Pub. Date: Oct. 7, 2021

(54) LIQUID CONTAINER

(71) Applicant: SEIKO EPSON CORPORATION, Tokyo (JP)

(72) Inventors: Noriyuki FUKASAWA, Matsumoto-shi (JP); Hiroyuki KAWATE, Hokuto-shi (JP); Taku ISHIZAWA, Matsumoto-shi (JP); Takumi NAGASHIMA, Matsumoto-shi (JP)

(73) Assignee: SEIKO EPSON CORPORATION, Tokyo (JP)

(21) Appl. No.: 17/221,496

(22) Filed: Apr. 2, 2021

(30) Foreign Application Priority Data
Apr. 3, 2020 (JP) 2020-067240

(51) Int. Cl. B41J 2/175

(52) U.S. Cl. CPC B41J 2/17513; B41J 2002/17516

(57) ABSTRACT

A liquid container includes: a bag that contains a liquid; and a pair of members configured to be reused when the liquid container is reassembled by replacing the bag used. The pair of members are fixed to each other by one or more swaging pins.

The present application is based on, and claims priority from JP Application Serial Number 2020-067240, filed Apr. 3, 2020, the disclosure of which is hereby incorporated by reference herein in its entirety.

### BACKGROUND

### 1. Technical Field

The present disclosure relates to liquid containers.

### 2. Related Art

Some ink cartridges include: a replaceable ink bag; a case that accommodates the ink bag; and a lid that covers one surface of the case. JP-A-5-16377 discloses an example of such ink cartridges which includes: a lid that has pairs of projections and claws; and a case that has pairs of holes and notches. When the lid is attached to the case, the projections of the lid are inserted into the respective holes of the case, and the claws of the lid mate with the respective recesses of the case in a snap-fit manner. In addition, the case also has a rear surface with a notch, which is covered with a caution label bonded on both the rear and upper surfaces of the case. To detach the lid from the case, a user has only to insert a tool into the case through the notch and then twist this tool.

As opposed to ink cartridges in which a lid is ultrasonically welded to a case, the above ink cartridge can be continuously used without the case and the lid discarded even after the ink bag has become empty. When the ink is fully consumed, a user can replace the empty ink bag with a new one by detaching the lid from the case in the above manner. Furthermore, the caution label that is bonded on the ridge between the case and the lid helps prevent the lid from being accidentally detached from the case, for example, when the ink cartridge is vibrated or shocked. Also, the caution label that hides the notch is effective in reducing the risk of a user detaching the lid deliberately.

The disclosed ink cartridge, unfortunately, may have some disadvantages. The caution label that has been bonded to the case of the ink cartridge may adhere to the case with time and due to temperature changes, and thus a user has trouble peeling off the caution label when replacing the ink bag. In this case, if the user peels off this caution label by using a certain tool, he/she may accidentally damage the case or the lid of the ink cartridge or may break the claws that have lost their sufficient flexibility by undergoing temperature changes. In which case, the case or lid can be no longer used.

### SUMMARY

The present disclosure is a liquid container that includes: a bag that contains a liquid; and a pair of members configured to be reused when the liquid container is reassembled by replacing the bag used. The pair of members are fixed to each other by one or more swaging pins.

### BRIEF DESCRIPTION OF THE DRAWINGS

FIG. 1 is a perspective view of a liquid container in a first embodiment of the present disclosure.

FIG. 2 is an exploded perspective view of the liquid container.

FIG. 3 is a top view of the liquid container.

FIG. 4 is a cross-sectional view of the liquid container taken along the line IV-IV in FIG. 3.

FIG. 5 is a perspective view of a liquid container in a second embodiment of the present disclosure.

FIG. 6 is an exploded perspective view of the liquid container.

FIG. 7 is a top view of the liquid container.

FIG. 8 is a side view of the liquid container.

FIG. 9 is a cross-sectional view of the liquid container taken along the line IX-IX in FIG. 7.

FIG. 10 is a perspective view of a liquid container in a third embodiment of the present disclosure.

FIG. 11 is an exploded perspective view of the liquid container.

FIG. 12 is a front view of the liquid container.

FIG. 13 is a top view of the liquid container.

FIG. 14 is a cross-sectional view of the liquid container taken along the line XIV-XIV in FIG. 13.

FIG. 15 is a perspective view of the fixing member and the bag to be mounted in the liquid container.

FIG. 16 is a perspective view of the bag and the fixing member mounted in the liquid container with the ends of the swaging pins deformed.

### DESCRIPTION OF EXEMPLARY EMBODIMENTS

### A. First Embodiment

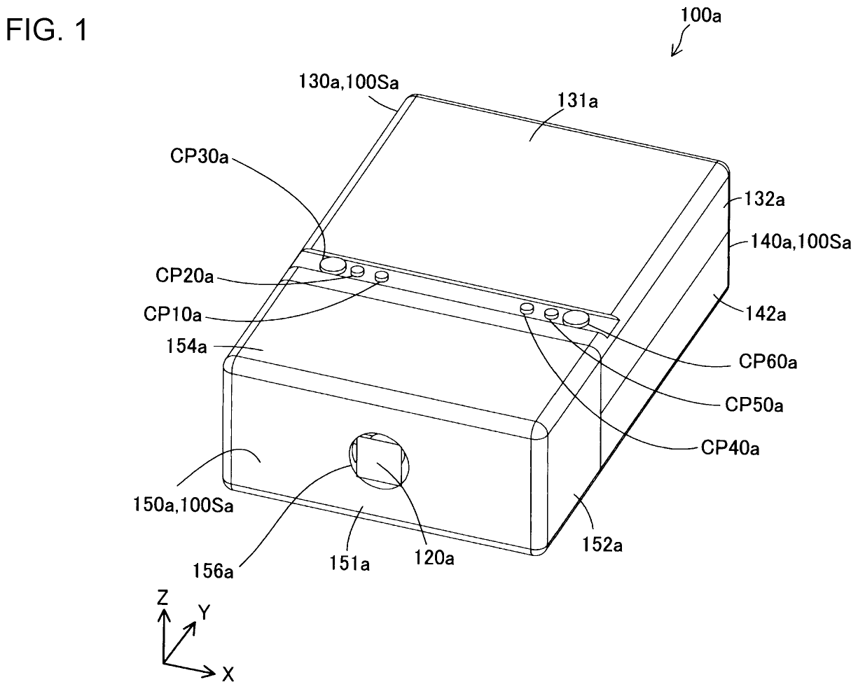

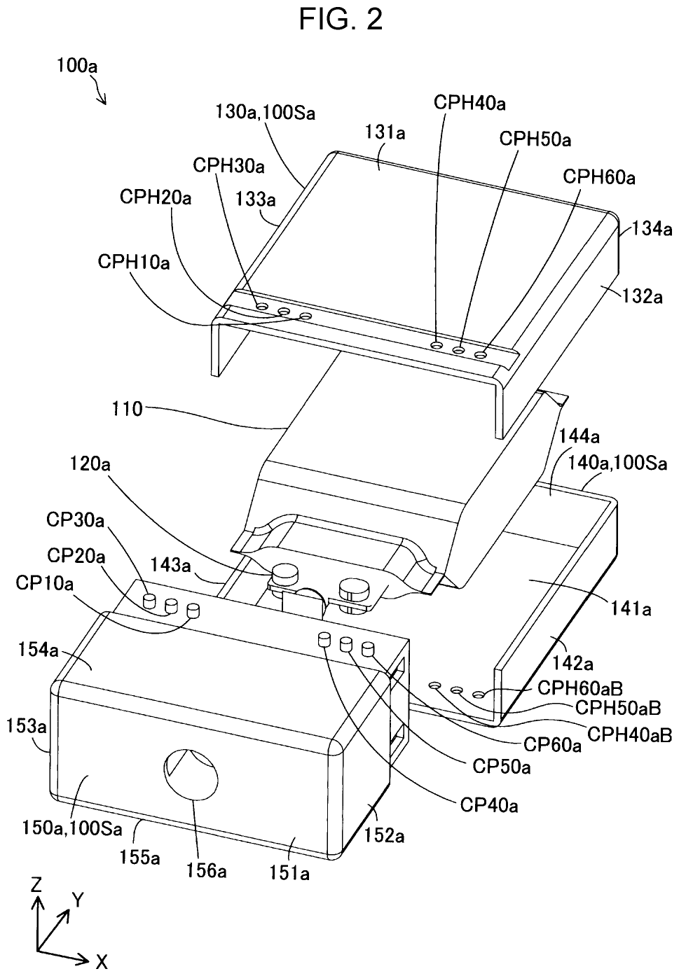

FIG. 1 is a perspective view of a liquid container 100a in a first embodiment of the present disclosure; FIG. 2 is an exploded perspective view of the liquid container 100a. When the liquid container 100a is mounted in a liquid consuming apparatus, a liquid contained in the liquid container 100a is supplied to the liquid consuming apparatus.

In FIG. 1, X-, Y-, and Z-axial arrows are described perpendicularly to one another. The Y-axial arrow is parallel to the long sides of the liquid container 100a. The liquid container 100a is inserted into the liquid consuming apparatus in the direction of the Y-axial arrow. The X-axial arrow is parallel to the short sides, or the width, of the liquid container 100a. The Z-axial arrow is parallel to the height of the liquid container 100a. It should be noted that those X-, Y-, and Z-axial arrows are consistently related to those in the other drawings. Hereinafter, the direction of the X-axial arrow is defined as the +X direction whereas the opposite direction is defined as the −X direction; the direction of the Y-axial arrow is defined as the +Y direction whereas the opposite direction is defined as the −Y direction; and the direction of the Z-axial arrow is defined as the +Z direction whereas the opposite direction is defined as the −Z direction.

The liquid container 100a includes a bag 110, a fixing member 120a, a first case 130a, a second case 140a, and a lid 150a, all of which constitute an outer shell 100Sa, as illustrated in FIG. 1. The outer shell 100Sa is a substantially rectangular parallelepiped case that surrounds and accommodates the bag 110. The liquid container 100a can be reassembled without the outer shell 100Sa discarded when both the bag 110 that has been empty and the fixing member 120a are replaced.

The bag 110, which may be made of a flexible sheet material, contains a liquid to be supplied to the outside, as illustrated in FIG. 2. The bag 110 shrinks mainly in the Z direction in proportion to the amount of liquid supplied to the outside, namely, in inverse proportion to the amount of liquid left therein.

The fixing member 120a is a member equipped with the bag 110, which fixes the bag 110 to the outer shell 100Sa, as illustrated in FIG. 2. The fixing member 120a has a liquid passage that leads to the interior of the bag 110. Through this liquid passage, the liquid is to be supplied from the bag 110 to the outside of the liquid container 100a. As illustrated in FIGS. 1 and 2, the liquid passage is formed in the Y direction, and the opening of the liquid passage in the fixing member 120a is sealed with a rectangular film.

The first case 130a includes a first wall 131a, a second wall 132a, a third wall 133a, and a fourth wall 134a, as illustrated in FIG. 2, each of which may have a substantially rectangular, flat shape. Herein, the word “wall” refers to a flat part that may have some steps, grooves, uneven or inclined areas, holes, or slits.

The first wall 131a is a substantially rectangular, flat part disposed in parallel to the XY plane in FIGS. 1 and 2. The second wall 132a is a flat part that extends vertically from one short side of the first wall 131a. The third wall 133a is a flat part that extends vertically from the other short side of the first wall 131a and faces the second wall 132a. The fourth wall 134a is a flat part that extends vertically from one long side of the first wall 131a. One short side of the fourth wall 134a is coupled to a short side of the second wall 132a, whereas the other short side of the fourth wall 134a is coupled to a short side of the third wall 133a.

The first wall 131a, the second wall 132a, the third wall 133a, and the fourth wall 134a of the first case 130a define a substantially rectangular parallelepiped space in which a portion of the bag 110 is accommodated, as illustrated in FIG. 2.

The first wall 131a has six through-holes: through-holes CPH10a to CPH60a, as illustrated in FIG. 2. The through-holes CPH10a to CPH60a are arrayed near and along one of the short sides of the first wall 131a which is not coupled to the fourth wall 134a. In other words, the through-holes CPH10a to CPH60a are arrayed in the +X direction in FIG. 2.

The second case 140a includes a first wall 141a, a second wall 142a, a third wall 143a, and a fourth wall 144a, as illustrated in FIG. 2. The first wall 141a has six through-holes: through-holes CPH10aB to CPH60aB. It should be noted that the third wall 143a and the through-holes CPH10aB to CPH30aB are hidden in FIGS. 1 and 2.

When the liquid container 100a is completely assembled, the second case 140a is substantially symmetrical to the first case 130a with respect to the plane parallel to the XY plane. The first wall 141a, the second wall 142a, the third wall 143a, and the fourth wall 144a of the second case 140a define a substantially rectangular parallelepiped space in which another portion of the bag 110 is accommodated, as illustrated in FIG. 2.

The lid 150a includes a first wall 151a, a second wall 152a, a third wall 153a, a fourth wall 154a, and a fifth wall 155a, as illustrated in FIG. 2, each of which may have a substantially rectangular, flat shape.

The first wall 151a is a substantially rectangular, flat part disposed in parallel to the XZ plane in FIGS. 1 and 2. The second wall 152a is a flat part that extends vertically from one short side of the first wall 151a. The third wall 153a is a flat part that extends vertically from the other short side of the first wall 151a and faces the second wall 152a.

The fourth wall 154a is a flat part that extends vertically from one long side of the first wall 151a. The fifth wall 155a is a flat part that extends vertically from the other long side of the first wall 151a and faces the fourth wall 154a.

One short side of the fourth wall 154a is coupled to a side of the second wall 152a, whereas the other short side of the fourth wall 154a is coupled to a side of the third wall 153a. One short side of the fifth wall 155a is coupled to another side of the second wall 152a, whereas the other short side of the fifth wall 155a is coupled to another side of the third wall 153a.

The first wall 151a, the second wall 152a, the third wall 153a, the fourth wall 154a, and the fifth wall 155a of the lid 150a define a substantially rectangular parallelepiped space in which still another portion of the bag 110 and the fixing member 120a are accommodated, as illustrated in FIG. 2.

The first wall 151a has a through-hole 156a that formed vertically across the first wall 151a substantially at the center. The first wall 151a is fixed to the fixing member 120a while positioning a portion of the fixing member 120a inside the through-hole 156a, so that the bag 110 is fixed to an outer shell 100Sa. Through the through-hole 156a, the liquid passage of the fixing member 120a leads to the outside, as illustrated in FIG. 1. The end of the liquid passage of the fixing member 120a is sealed with the rectangular film, as illustrated in FIG. 1.

The fourth wall 154a has six projections: projections CP10a to CP60a. The projections CP10a to CP60a are arrayed near and along one of the long sides of the fourth wall 154a which is not coupled to the first wall 151a. In other words, the projections CP10a to CP60a are arrayed in the +X direction in FIG. 2. All of the projections CP10a to CP60a protrude vertically from the fourth wall 154a in the +Z direction in FIG. 2.

Each of the projections CP10a to CP60a may act as a swaging pin. Herein, the “swaging pin” refers to a member that fixes a pair of members to each other with its end deformed. Functions of the projections CP10a to CP60a will be described later.

The fifth wall 155a has sixth projections: projections CP10aB to CP60aB. When the liquid container 100a is completely assembled, the fifth wall 155a is substantially symmetrical to the fourth wall 154a with respect to the plane parallel to the XY plane. It should be noted that the fifth wall 155a and the projections CP10aB to CP60aB are hidden in FIGS. 1 and 2.

To assemble the liquid container 100a, the fixing member 120a equipped with the bag 110, the first case 130a, the second case 140a, and the lid 150a are first prepared, as illustrated in FIG. 2. Then, the fixing member 120a is attached to the lid 150a, after which the first case 130a is joined to the second case 140a with both the lid 150a and the bag 110 therebetween.

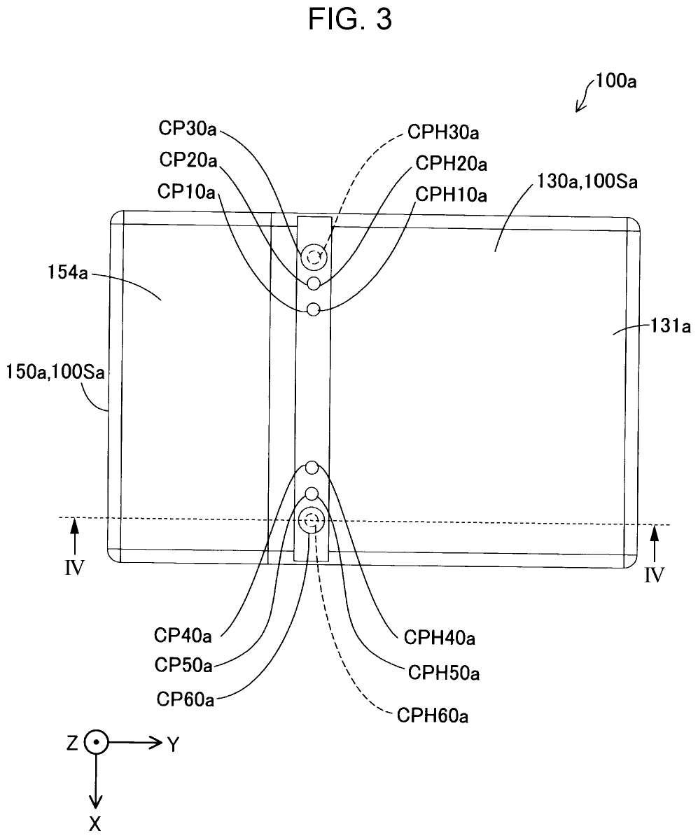

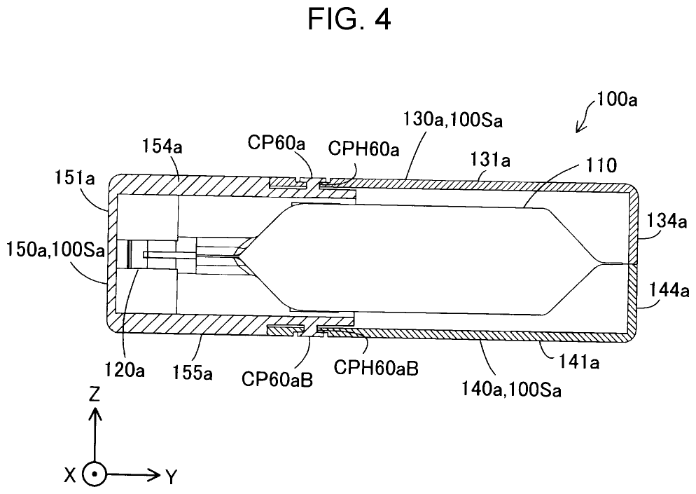

FIG. 3 is a top view of the liquid container 100a; FIG. 4 is a cross-sectional view of the liquid container 100a taken along the line IV-IV in FIG. 3. When joining the first case 130a to the second case 140a, a user inserts the projections CP10a to CP60a of the lid 150a, respectively, into the through-holes CPH10a to CPH60a of the first case 130a, as illustrated in FIGS. 2 to 4. When using the lid 150a, the first case 130a, and the second case 140a for the first time to assemble the liquid container 100a, he/she deforms the ends of the projections CP30a and CP60a, which are ones of the projections CP10a to CP60a positioned near the respective edges of the fourth wall 154a, as illustrated in FIGS. 1, 3, and 4. More specifically, he/she widens the ends of the projections CP30a and CP60a to the extent that the end of the projection CP30a cannot be inserted into the through-hole CPH30a and the end of the projection CP60a cannot be inserted into the through-hole CPH60a. In this way, the first case 130a is fixed to the lid 150a by the projections CP30a and CP60a, each of which may act as the swaging pin.

Likewise, the user inserts the projections CP10aB to CP60aB of the lid 150a, respectively, into the through-holes CPH10aB to CPH60aB of the second case 140a. When using the lid 150a, the first case 130a, and the second case 140a for the first time to assemble the liquid container 100a, he/she deforms the ends of the projections CP30aB and CP60aB, which are ones of the projections CP10aB to CP60aB positioned near the respective edges of the fifth wall 155a. More specifically, he/she widens the ends of the projections CP30aB and CP60aB to the extent that the end of the projection CP30aB cannot be inserted into the through-hole CPH30aB and the end of the projection CP60aB cannot be inserted into the through-hole CPH60aB. In this way, the second case 140a is fixed to the lid 150a by the projections CP30aB and CP60aB, each of which may act as the swaging pin.

In the liquid container 100a, the lid 150a is provided with the projections CP10a to CP60a configured to fix the lid 150a to the first case 130a. Furthermore, the lid 150a is also provided with the projections CP10aB to CP60aB configured to fix the lid 150a to the second case 140a. When the liquid container 100a is completely assembled, the lid 150a is fixed to the first case 130a by the projections CP30a and CP60a, which are ones of the projections CP10a to CP60a, and the lid 150a is also fixed to the second case 140a by the projections CP30aB and CP60aB, which are ones of the projections CP10aB to CP60aB.

When the liquid in the bag 110 is fully consumed, a user needs to perform the following steps, including a step of replacing the empty bag 110 and the fixing member 120a with new ones, in order to reassemble the liquid container 100a. First, he/she breaks the ends of the projections CP30a, CP60a, CP30aB, and CP60aB, each of which may act as the swaging pin, and separates the first case 130a, the second case 140a, and the lid 150a from one another. Then, he/she detaches an old bag 110 and fixing member 120a from the lid 150a and in turn attaches a new bag 110 and fixing member 120a to the lid 150a. After that, he/she joins the first case 130a to the second case 140a with the lid 150a, the fixing member 120a and the bag 110 therebetween.

After the above steps, the user deforms and widens the ends of projections CP20a and CP50a, which are ones of the projections CP10a to CP60a, to the extent that the end of the projection CP20a cannot be inserted into the through-hole CPH20a and the end of the projection CP50a cannot be inserted into the through-hole CPH50a, like the projections CP30a and CP60a illustrated in FIGS. 1, 3, and 4. In this way, when the liquid container 100a is used for the second time, the lid 150a is fixed to the first case 130a by the projections CP20a and CP50a, each of which may act as the swaging pin.

Likewise, the user deforms and widens the ends of the projections CP20aB and CP50aB, which are ones of the projections CP10aB to CP60aB, to the extent that the end of the projection CP20aB cannot be inserted into the through-hole CPH20aB and the end of the projection CP50aB is inserted into the through-hole CPH50aB. In this way, when the liquid container 100a is used for the second time, the lid 150a is fixed to the second case 140a by the projections CP20aB and CP50aB, each of which may act as the swaging pin.

When the liquid in the replaced bag 110 is fully consumed again, the user has only to perform the above steps, including a step of replacing the empty bag 110 and the fixing member 120a with new ones, in order to assemble the liquid container 100a. At this time, however, he/she deforms and widens the ends of projections CP10a and CP40a, which are ones of the projections CP10a to CP60a, to the extent that the end of the projection CP10a cannot be inserted into the through-hole CPH10a and the end of the projection CP40a cannot be inserted into the through-hole CPH40a, like the projections CP30a and CP60a illustrated in FIGS. 1, 3, and 4. In this way, when the liquid container 100a is used for the third time, the lid 150a is fixed to the first case 130a by the projections CP10a and CP40a, each of which may act as the swaging pin.

Likewise, the user deforms and widens the ends of the projections CP10aB and CP40aB, which are ones of the projections CP10aB to CP60aB, to the extent that the projection CP10aB cannot be inserted into the through-hole CPH10aB and the end of the projection CP40aB cannot be inserted into the through-hole CPH40aB. In this way, when the liquid container 100a is used for the third time, the lid 150a is fixed to the second case 140a by the projections CP10aB and CP40aB, each of which may act as the swaging pin.

As described above, when replacing the fixing member 120a and the bag 110 in order to assemble the liquid container 100a, the user can separate the first case 130a, the second case 140a, and the lid 150a from one another simply by breaking some of the projections CP30a to CP60a and CP30aB to CP60aB, each of which may act as the swaging pin. Therefore, the configuration in the first embodiment enables the user to easily reassemble the liquid container 100a even if the liquid container 100a has undergone temperature changes.

After replacing the fixing member 120a and the bag 110, the user can fix the lid 150a, the first case 130a, and the second case 140a to one another simply by using unused ones of the projections CP10a to CP60a and CP10aB to CP60aB. Therefore, the configuration in the first embodiment, when the liquid container 100a is reassembled, can maintain the strength at which the first case 130a, the second case 140a, and the lid 150a are fixed to one another, regardless of how many times the first case 130a, the second case 140a, and the lid 150a have been reused.

In the first embodiment, the number of times that the first case 130a, the second case 140a, and the lid 150a can be reused is related to the number of projections of the lid 150a. Therefore, the user can easily know how many times the lid 150a, the first case 130a, and the second case 140a can be reused, based on the configuration of the liquid container 100a.

Herein, the combination of the lid 150a and the first case 130a or the combination of the lid 150a and the second case 140a in the first embodiment may correspond to a pair of members, and each of projections CP30a to CP60a and CP30aB to CP60aB in the first embodiment may correspond to a swaging pin.

### B. Second Embodiment

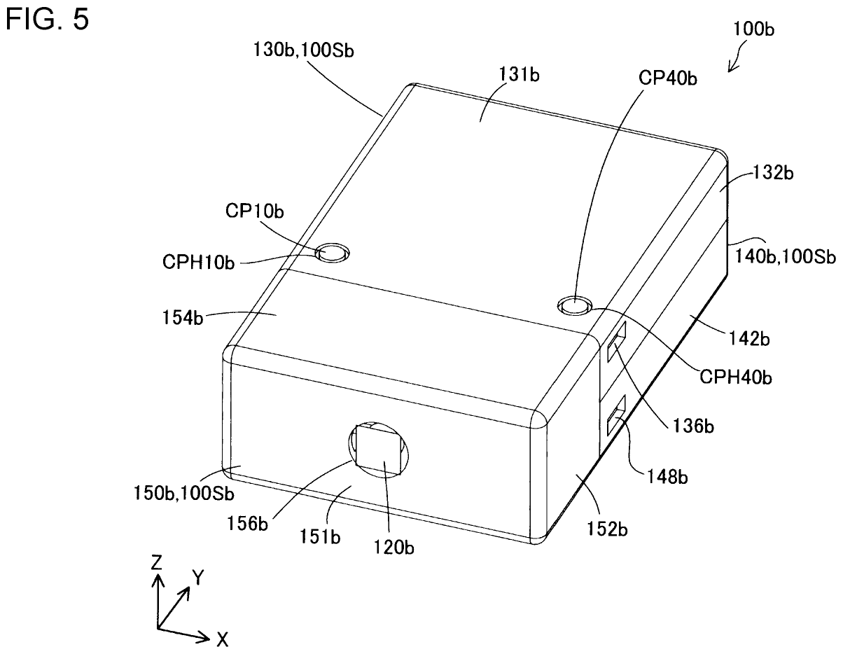

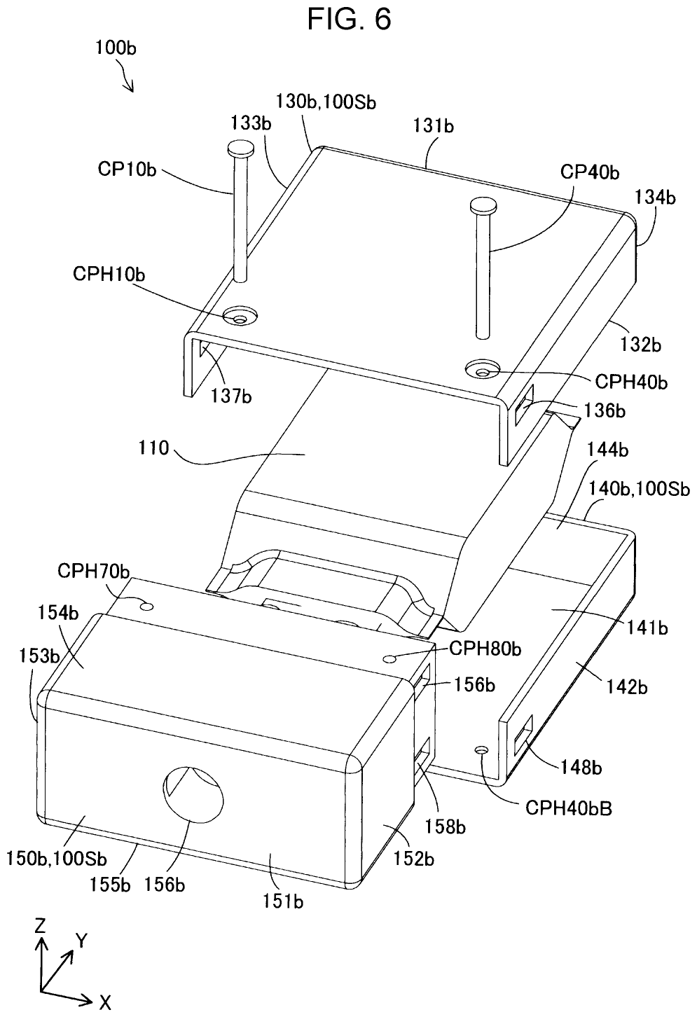

FIG. 5 is a perspective view of a liquid container 100b in a second embodiment of the present disclosure; FIG. 6 is an exploded perspective view of the liquid container 100b. Most of the configuration in the liquid container 100b is substantially the same as that in the liquid container 100a in the foregoing first embodiment. Thus, only different configuration features of the liquid container 100b will be described below. Therefore, configuration features of the liquid container 100b which will not be described below are substantially the same as those of the liquid container 100a. In individual drawings, components of the liquid container 100b which correspond to those in the liquid container 100a are denoted by reference characters ending in “b” instead of “a”.

In the liquid container 100b, a first wall 131b of a first case 130b includes two through-holes: through-holes CPH10b and CPH40b, instead of the through-holes CPH10a to CPH60a. The through-holes CPH10b and CPH40b are arrayed near and along one of the long sides of the first wall 131b which is not coupled to a fourth wall 134b. In other words, the through-holes CPH10b and CPH40b are arrayed in the +X direction in FIG. 6. Both of the through-holes CPH10b and CPH40b are formed vertically across the first wall 131b. Formed around the aperture of the through-hole CPH10b on the outer surface of an outer shell 100Sb is a countersink, which receives the flange of a swaging pin CP10b. Likewise, formed around the aperture of the through-hole CPH40b on the outer surface of the outer shell 100Sb is a countersink, which receives the flange of a swaging pin CP40b.

A second wall 132b of the first case 130b has a through-hole 136b, as illustrated in FIGS. 5 and 6, which is positioned near one of the long sides of the second wall 132b which is coupled to the first wall 131b and one of the short sides of the second wall 132b which is not coupled to the fourth wall 134b. The through-hole 136b is formed vertically across the second wall 132b. The through-hole 136b has a substantially rectangular shape with the long sides parallel to those of the second wall 132b. The through-hole 136b is formed so as to be elongated in the +Y axis in FIG. 6.

A third wall 133b of the first case 130b has a through-hole 137b, as illustrated in FIG. 6, which is positioned near one of the long sides of the third wall 133b which is coupled to the first wall 131b and one of the short sides of the third wall 133b which is not coupled to the fourth wall 134b. The through-hole 137b is formed vertically across the third wall 133b. The through-hole 137b has a substantially rectangular shape with the long sides parallel to those of the third wall 133b. The through-hole 137b is formed so as to be elongated in the +Y axis in FIG. 6.

When the liquid container 100b is completely assembled, a second case 140b is substantially symmetrical to the first case 130b with respect to the plane parallel to the XY plane, as illustrated in FIGS. 5 and 6.

A first wall 141b of the second case 140b has through-holes CPH10bB and CPH40bB. When the liquid container 100b is completely assembled, the through-hole CPH10bB is substantially symmetrical to the through-hole CPH10b of the first case 130b with respect to the plane parallel to the XY plane, whereas the through-hole CPH40bB is substantially symmetrical to the through-hole CPH40b of the first case 130b with respect to the plane parallel to the XY plane.

A second wall 142b of the second case 140b has a through-hole 148b. When the liquid container 100b is completely assembled, the through-hole 148b is substantially symmetrical to the through-hole 136b of the first case 130b with respect to the plane parallel to the XY plane, as illustrated in FIGS. 5 and 6. A third wall 143b of a second case 140b has a through-hole 149b. When the liquid container 100b is completely assembled, the through-hole 149b is substantially symmetrical to the through-hole 137b of the first case 130b with respect to the plane parallel to the XY plane. It should be noted that the third wall 143b and the through-hole 149b of the second case 140b are hidden in FIGS. 5 and 6.

A fourth wall 154b of the lid 150b of the liquid container 100b has two through-holes: through-holes CPH70b and CPH80b, as illustrated in FIG. 6, instead of the above projections CP10a to CP60a. The through-holes CPH70b and CPH80b are arrayed near and along one of the long sides of the fourth wall 154b which is not coupled to a first wall 151b. In other words, the through-holes CPH70b and CPH80b are arrayed in the +X direction in FIG. 6. Both of the through-holes CPH70b and CPH80b are formed vertically across the fourth wall 154b.

A fifth wall 155b of the lid 150b is substantially symmetrical to the fourth wall 154b with respect to the plane parallel to the XY plane. The fifth wall 155b of the lid 150b has two through-holes: through-holes CPH70bB and CPH80bB, instead of the above projections CP10aB to CP60aB. The through-hole CPH70bB is substantially symmetrical to the through-hole CPH70b of the fourth wall 154b with respect to the plane parallel to the XY plane, whereas the through-hole CPH80bB is substantially symmetrical to the through-hole CPH80b of the fourth wall 154b with respect to the plane parallel to the XY plane. It should be noted that the fifth wall 155b and the through-holes CPH70bB and CPH80bB are hidden in FIGS. 5 and 6.

A second wall 152b of the lid 150b has through-holes 156b and 158b, as illustrated in FIG. 6. The through-holes 156b and 158b are arrayed near and along one of the short sides of the second wall 152b which is not coupled to the first wall 151b. In other words, the through-holes 156b and 158b are arrayed in the +Z direction in FIG. 6. Both of the through-holes 156b and 158b are formed vertically across the second wall 152b. Each of the through-holes 156b and 158b has a substantially rectangular shape with the long sides parallel to those of the second wall 152b. Each of the through-holes 156b and 158b is formed so as to be elongated in the +Y axis in FIG. 6.

A third wall 153b of the lid 150b is substantially symmetrical to the second wall 152b with respect to the plane parallel to the YZ plane. The third wall 153b of the lid 150b has through-holes 157b and 159b. The through-hole 157b is substantially symmetrical to the through-hole 156b of the second wall 152b with respect to the plane parallel to the YZ plane, whereas the through-hole 159b is substantially symmetrical to the through-hole 158b of the fourth wall 154b with respect to the plane parallel to the YZ plane. It should be noted that the third wall 153b and the through-holes 157b and 159b are hidden in FIGS. 5 and 6.

When the lid 150b, the first case 130b, and the second case 140b that have been joined together are viewed from the −Z direction, the through-hole CPH10b of the first case 130b is overlaid with the through-hole CPH70b of the lid 150b, and the through-hole CPH70bB of the lid 150b is overlaid with the through-hole CPH10bB of the second case 140b, as illustrated in FIG. 6.

Likewise, when the lid 150b, the first case 130b, and the second case 140b that have been joined together are viewed from the −Z direction, the through-hole CPH40b of the first case 130b is overlaid with the through-hole CPH80b of the lid 150b, and the through-hole CPH80bB of the lid 150b is overlaid with the through-hole CPH40bB of the second case 140b, as illustrated in FIG. 6.

When the lid 150b, the first case 130b, and the second case 140b that have been joined together are viewed from the −X direction, the through-hole 136b of the first case 130b is overlaid with the through-hole 156b of the lid 150b, and the through-hole 148b of the second case 140b is overlaid with the through-hole 158b of the lid 150b, as illustrated in FIG. 6.

Likewise, when the lid 150b, the first case 130b, and the second case 140b that have been joined together are viewed from the +X direction, the through-hole 137b of the first case 130b is overlaid with the through-hole 157b of the lid 150b, and the through-hole 149b of the second case 140b is overlaid with the through-hole 159b of the lid 150b.

The liquid container 100b is provided with the swaging pins CP10b and CP40b, each of which is a bar-shaped member that has a flange at its end and that is independent of both the first case 130b and the second case 140b, unlike the projections CP10a to CP60a and CP10aB to CP60aB in the foregoing first embodiment.

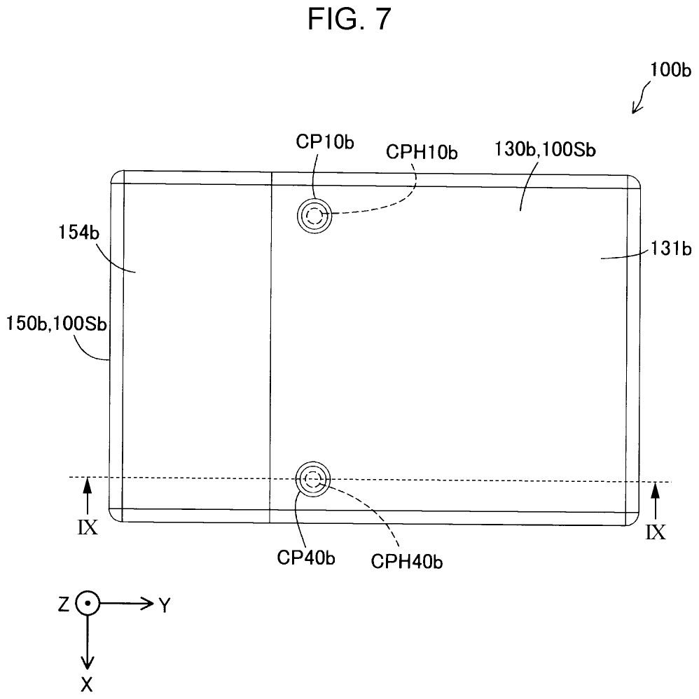

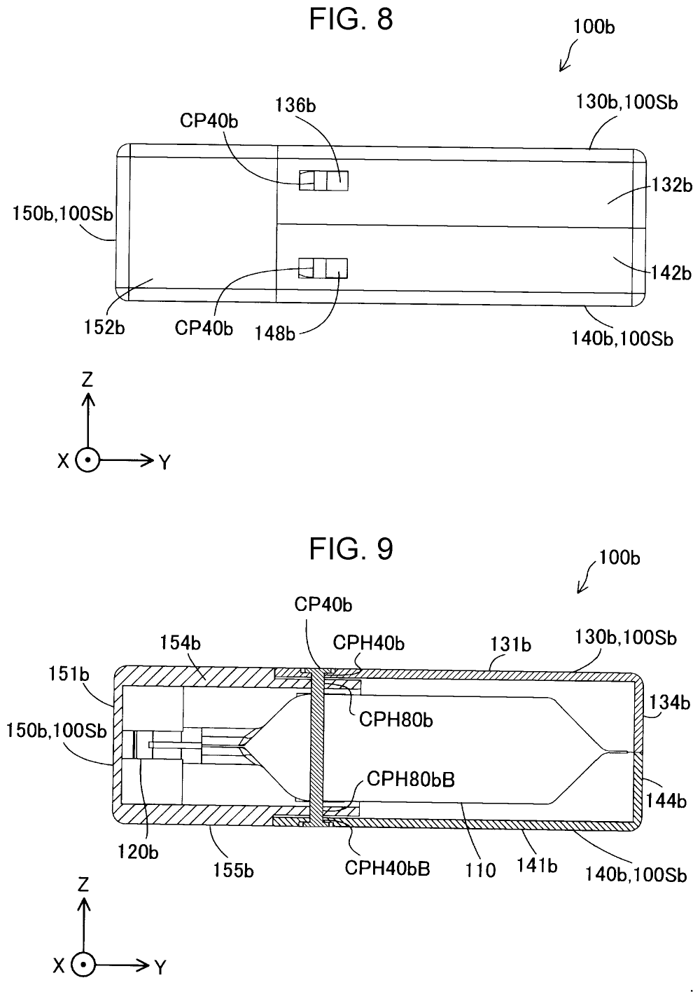

FIG. 7 is a top view of the liquid container 100b; FIG. 8 is a side view of the liquid container 100b; and FIG. 9 is a cross-sectional view of the liquid container 100b taken along the line IX-IX in FIG. 7.

When joining the first case 130b, the second case 140b, and the lid 150b together, a user passes the swaging pin CP10b through the through-hole CPH10b of the first case 130b, the through-holes CPH70b and CPH70bB of the lid 150b, and the through-hole CPH10bB of the second case 140b while aligning the through-holes CPH10b, CPH70b, CPH70bB, and CPH10bB with one another, as illustrated in FIGS. 6 and 7. Likewise, the user passes the swaging pin CP40b through the through-hole CPH40b of the first case 130b, the through-holes CPH80b and CPH80bB of the lid 150b, and the through-hole CPH40bB of the second case 140b while aligning the through-holes CPH40b, CPH80b, CPH80bB, and CPH40bB with one another, as illustrated in FIGS. 6, 7, and 9. In this case, the swaging pins CP10b and CP40b do not interfere with the mounting of a bag 110 and a fixing member 120b inside an outer shell 100Sb.

After having passed the swaging pins CP10b and CP40b, the user deforms the end of the swaging pin CP10b which protrudes from the second case 140b via the through-hole CPH10bB. More specifically, he/she widens the end of the swaging pin CP10b to the extent that the end of the swaging pin CP10b cannot be inserted into the through-hole CPH10bB of the second case 140b, thereby forming a flange of the swaging pin CP10b. Likewise, he/she deforms the end of the swaging pin CP40b which protrudes from the second case 140b via the through-hole CPH40bB. More specifically, he/she widens the end of the swaging pin CP40b to the extent that the end of the swaging pin CP40b cannot be inserted into the through-hole CPH40bB of the second case 140b, thereby forming a flange of the swaging pin CP40b, as illustrated in FIG. 9. In this way, the first case 130b, the second case 140b, and the lid 150b are fixed to one another by the swaging pins CP10b and CP40b.

When the liquid container 100b is completely assembled, the first case 130b, the second case 140b, and the lid 150b are fixed to one another by the swaging pins CP10b and CP40b, as illustrated in FIGS. 5, 7, and 9.

When the liquid container 100b is completely assembled, the swaging pin CP40b is viewable from the outside via the through-hole 136b of the first case 130b and the through-hole 156b of the lid 150b, as illustrated in FIGS. 6 and 8. In addition, the swaging pin CP40b is also viewable from the outside via the through-hole 148b of the second case 140b and the through-hole 158b of the lid 150b, as illustrated in FIGS. 6 and 8.

Likewise, the swaging pin CP10b is viewable from the outside via the through-hole 137b of the first case 130b and the through-hole 157b of the lid 150b. In addition, the swaging pin CP10b is also viewable from the outside via the through-hole 149b of the second case 140b and the through-hole 159b of the lid 150b.

When the liquid in the bag 110 is fully consumed, the user needs to perform the following steps, including a step of replacing the fixing member 120b and the bag 110 with new ones, in order to reassemble the liquid container 100b.

The user inserts a cutting tool into the outer shell 100Sb via the through-hole 137b of the first case 130b and the through-hole 157b of the lid 150b or via the through-hole 149b of the second case 140b and the through-hole 159b of the lid 150b and then cuts off the swaging pin CP10b. Likewise, he/she inserts the cutting tool into the outer shell 100Sb via the through-hole 136b of the first case 130b and the through-hole 156b of the lid 150b or via the through-hole 148b of the second case 140b and the through-hole 158b of the lid 150b and then the cut off the swaging pin CP40b, as illustrated in FIGS. 6 and 8. Then, he/she removes the swaging pins CP10b and CP40b from the outer shell 100Sb and then separates the first case 130b, the second case 140b, and the lid 150b from one another.

The configuration in the second embodiment enables the user to easily break the swaging pins CP10b and CP40b from the outside of the outer shell 100Sb via through-holes formed in the outer shell 100Sb and then remove the swaging pins CP10b and CP40b therefrom.

After having separated the first case 130b, the second case 140b, and the lid 150b from one another, the user attaches a new fixing member 120b and bag 110 to the lid 150b. Then, he/she joins the lid 150b, the first case 130b, and the second case 140b together with the fixing member 120b and the bag 110 therebetween.

After having joined the lid 150b, the first case 130b, and the second case 140b together, the user passes a new swaging pin CP10b through the through-hole CPH10b of the first case 130b, the through-hole CPH70b and CPH70bB of the lid 150b, and the through-hole CPH10bB of the second case 140b while aligning the through-holes CPH10b, CPH70b, CPH70bB, and CPH10bB with one another, as illustrated in FIGS. 6 and 7. Likewise, he/she passes a new swaging pin CP40b through the through-hole CPH40b of the first case 130b, the through-hole CPH80b and CPH80bB of the lid 150b, and the through-hole CPH40bB of the second case 140b while aligning the through-holes CPH40b, CPH80b, CPH80bB, and CPH40bB with one another, as illustrated in FIGS. 6, 7, and 9. Then, he/she widens the end of the swaging pin CP10b to the extent that the end of the swaging pin CP10b cannot be inserted into the through-hole CPH10bB of the second case 140b, thereby forming the flange of the swaging pin CP10b. Likewise, he/she widens the end of the swaging pin CP40b to the extent that the end of the swaging pin CP40b cannot be inserted into the through-hole CPH40bB of the second case 140b, thereby forming the flange of the swaging pin CP40b, as illustrated in FIG. 9. In this way, the first case 130b, the second case 140b, and the lid 150b are fixed to one another by the swaging pins CP10b and CP40b.

To reassemble the liquid container 100b, the user can fix the lid 150b, the first case 130b, and the second case 140b to one another simply by using new swaging pins CP10b and CP40b. Therefore, the configuration in the second embodiment, when the liquid container 100b is reassembled, can maintain the strength at which the first case 130b, the second case 140b, and the lid 150b are fixed to one another, regardless of how many times the first case 130b, the second case 140b, and the lid 150b have been reused.

In the second embodiment, the user can reuse the first case 130b, the second case 140b, and the lid 150b regardless of how many times the swaging pins CP10b and CP40b have been broken in order to assemble the liquid container 100b.

In the second embodiment, the liquid container 100b permits the swaging pins CP10b and CP40b to be deformed or damaged when the lid 150b, the first case 130b, and the second case 140b are detached from one another. This is because the swaging pins CP10b and CP40b can be replaced with new ones when the liquid container 100b is reassembled. However, it is preferable for the lid 150b, the first case 130b, and the second case 140b not to be deformed or damaged when the lid 150b, the first case 130b, and the second case 140b are detached from one another. This is because all of the lid 150b, the first case 130b, and the second case 140b need to be reused when the liquid container 100b is reassembled. In the second embodiment, as described above, the combination of the swaging pins CP10b and CP40b and the combination of the lid 150b, the first case 130b, and the second case 140b have different roles and functions. This configuration makes it possible to easily design parts of the lid 150b, the first case 130b, and the second case 140b which receive the swaging pins CP10b and CP40b.

Herein, the combination of the lid 150b and the first case 130b or the combination of the lid 150b and the second case 140b in the second embodiment may correspond to a pair of members.

### C. Third Embodiment

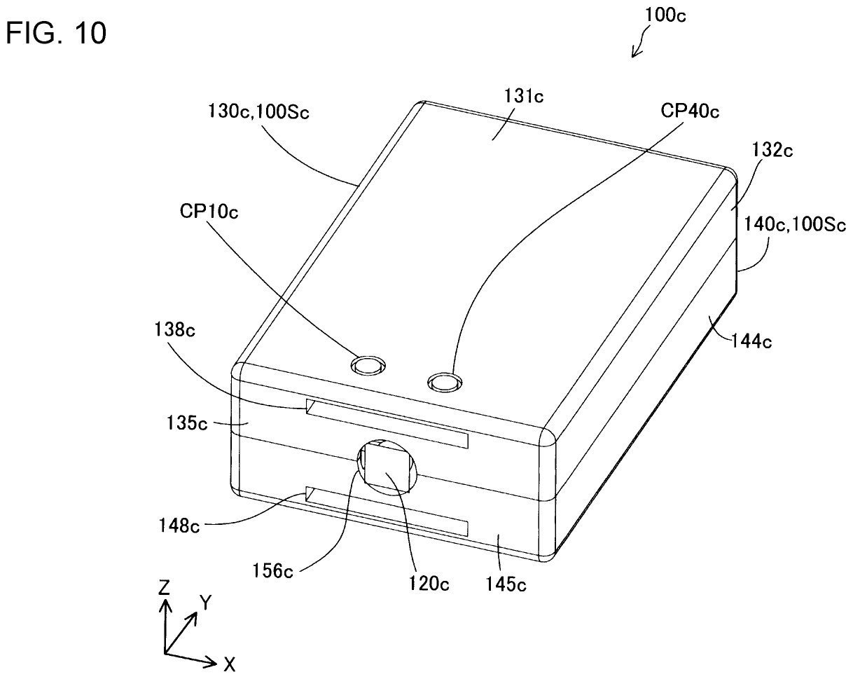

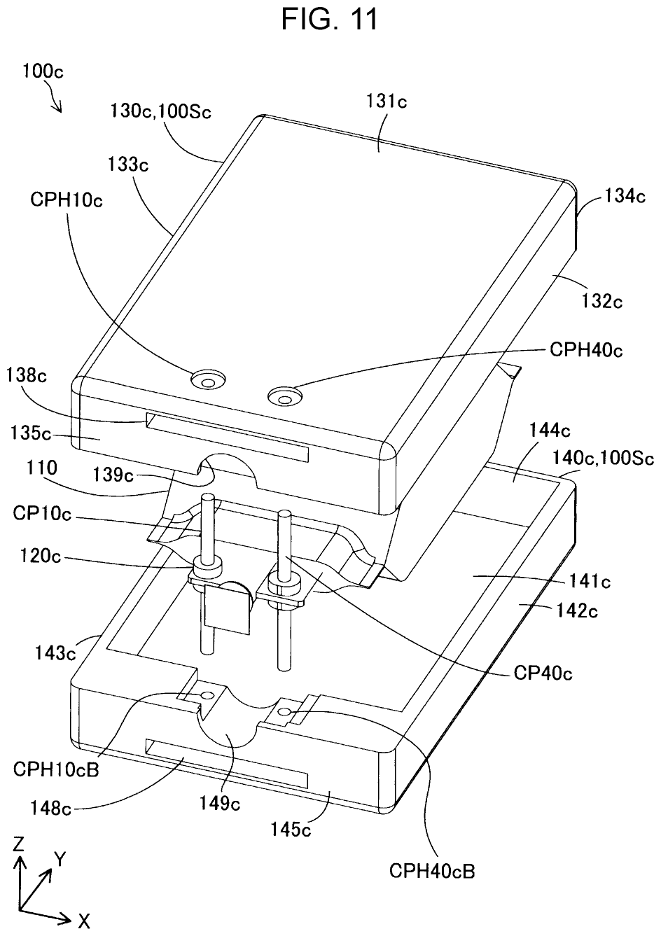

FIG. 10 is a perspective view of a liquid container 100c in a third embodiment of the present disclosure; FIG. 11 is an exploded perspective view of the liquid container 100c. Most of the configuration in the liquid container 100c is substantially the same as that in the liquid container 100b in the foregoing second embodiment. Thus, only different configuration features of the liquid container 100c will be described below. Thus, configuration features of the liquid container 100c which will not be described below are substantially the same as those of the liquid container 100b. In individual drawings, components of the liquid container 100c which correspond to those in the liquid container 100b are denoted by reference characters ending in “c” instead of “b”.

A first case 130c of the liquid container 100c includes a first wall 131c, a second wall 132c, a third wall 133c, a fourth wall 134c, and a fifth wall 135c. The fifth wall 135c, which may be a substantially rectangular, flat shape and parallel to the ZX plane, protrudes vertically from one short side of the first wall 131c and faces the fourth wall 134c. One short side of the fifth wall 135c is coupled to one short side of the second wall 132c, whereas the other short side of the fifth wall 135c is coupled to one short side of the third wall 133c. The fifth wall 135c is greater in thickness than any of the second wall 132c, the third wall 133c, and the fourth wall 134c.

The fifth wall 135c of the first case 130c includes two through-holes; through-holes CPH10c and CPH40c, which are formed across the fifth wall 135c in parallel with the short sides of the fifth wall 135c, or in the +Z direction in FIG. 11. Both of the through-holes CPH10c and CPH40c are arrayed in the +X direction in FIG. 11. Each of the through-holes CPH10c and CPH40c is open in a portion of the outer surface of an outer shell 100Sc which forms the first wall 131c. Formed around the through-holes CPH10c and CPH40c are countersinks, which receive flanges of the swaging pins CP10c and CP40c, as illustrated in FIG. 11.

The fifth wall 135c further includes a through-hole 138c formed vertically across the fifth wall 135c. The through-hole 138c is positioned near one of the long sides of the fifth wall 135c which is coupled to the first wall 131c. The through-hole 138c has a substantially rectangular shape with its long sides parallel to those of the fifth wall 135c and is elongated in the +X direction in FIGS. 10 and 11. The through-hole 138c is positioned within an area containing both the through-holes CPH10c and CPH40c, as viewed from the +X direction. In other words, the through-hole 138c is formed inside the fifth wall 135c so as to intersect both of the through-holes CPH10c and CPH40c.

The fifth wall 135c further includes a notch 139c at substantially the center of one of the long sides of the fifth wall 135c which is not coupled to the first wall 131c. The notch 139c, which may have a semicircular shape, is formed vertically across the fifth wall 135c.

The second case 140c includes a first wall 141c, a second wall 142c, a third wall 143c, a fourth wall 144c, and a fifth wall 145c, as illustrated in FIG. 11. The fifth wall 145c includes through-holes CPH10cB, CPH40cB, and 148c and a notch 149c. When the liquid container 100c is completely assembled, the second case 140c is substantially symmetrical to the first case 130c with respect to the plane parallel to the XY plane.

When the liquid container 100c is completely assembled, the through-hole CPH10cB of the second case 140c is substantially symmetrical to the through-hole CPH10c of the first case 130c with respect to the plane parallel to the XY plane, whereas the through-hole CPH40cB of the second case 140c is substantially symmetrical to the through-hole CPH40c of the first case 130c with respect to the plane parallel to the XY plane. When the liquid container 100c is completely assembled, the through-hole 148c of the second case 140c is substantially symmetrical to the through-hole 138c of the first case 130c with respect to the plane parallel to the XY plane.

When the first case 130c and the second case 140c that have been joined together are viewed from the −Z direction, the through-hole CPH10c of the first case 130c is overlaid with the through-hole CPH10cB of the second case 140c, and the through-hole CPH40c of the first case 130c is overlaid with the through-hole CPH40cB of the second case 140c, as illustrated in FIG. 11.

When the liquid container 100c is completely assembled, the notch 149c of the second case 140c is substantially symmetrical to the notch 139c of the first case 130c with respect to the plane parallel to the XY plane.

When the liquid container 100c is completely assembled, the notch 139c of the fifth wall 135c of the first case 130c and the notch 149c of the fifth wall 145c of the second case 140c form a single through-hole across an outer shell 100Sc. Both the first case 130c and the second case 140c fix a fixing member 120c while positioning a portion of the fixing member 120c inside the above through-hole, thereby fixing a bag 110 to the outer shell 100Sc. Via this through-hole, a liquid passage of the fixing member 120c leads to the outside, as illustrated in FIG. 10. The end of the liquid passage of the fixing member 120c is sealed by a rectangular film, as illustrated in FIG. 10.

The fixing member 120c has two swaging pins: swaging pins CP10c and CP40c, as illustrated in FIG. 11, each of which is a bar-shaped member extending vertically to the liquid passage of the fixing member 120c which is coupled to the bag 110. The swaging pins CP10c and CP40c extend in the ±Z directions in FIG. 11 and are arranged on the respective sides of the liquid passage.

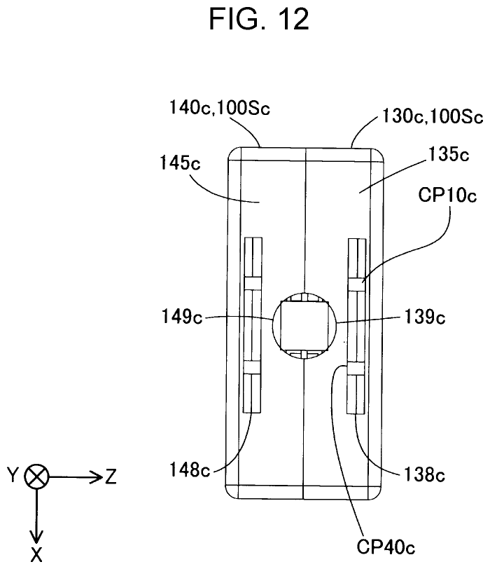

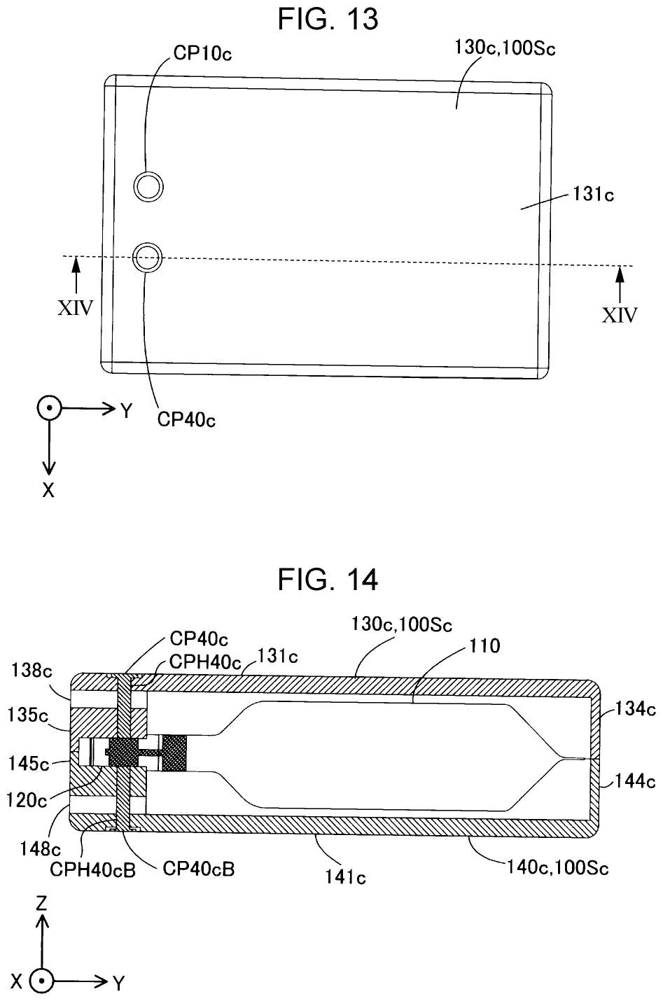

FIG. 12 is a front view of the liquid container 100c; FIG. 13 is a top view of the liquid container 100c; and FIG. 14 is a cross-sectional view of the liquid container 100c taken along the line XIV-XIV in FIG. 13.

When bonding the first case 130c to the second case 140c, the user passes the swaging pin CP10c of the fixing member 120c into both the through-hole CPH10c of the first case 130c and the through-hole CPH10cB of the second case 140c while aligning the through-holes CPH10c and the CPH10cB with each other. Likewise, the user passes the swaging pin CP40c of the fixing member 120c into both the through-hole CPH40c of the first case 130c and the through-hole CPH40cB of the second case 140c while aligning the through-holes CPH40c and CPH40cB with each other, as illustrated in FIGS. 11 and 14.

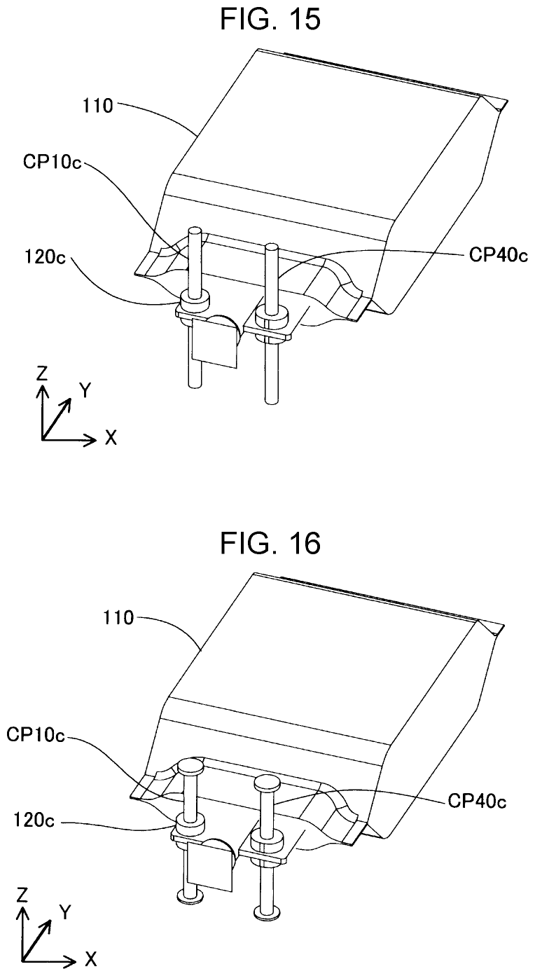

FIG. 15 is a perspective view of the fixing member 120c and the bag 110 to be mounted in the liquid container 100c; FIG. 16 is a perspective view of the bag 110 and the fixing member 120c mounted in the liquid container 100c with the ends of the swaging pins CP10c and CP40c deformed.

After having passed both the swaging pins CP10c and CP40c, the user deforms the end of the swaging pin CP10c which protrudes from the first case 130c. More specifically, he/she widens the end of the swaging pin CP10c to the extent that the end of the swaging pin CP10c cannot be inserted into the through-hole CPH10cB, thereby forming a flange of the swaging pin CP10c, as illustrated in FIGS. 14 and 16.

Likewise, the user deforms the end of the swaging pin CP10c which protrudes from the second case 140c via the through-hole CPH40c. Furthermore, the user deforms both ends of the swaging pin CP40c which protrude from the first case 130c via the through-hole CPH40c and from the second case 140c via the through-hole CPH40cB. In this way, the first case 130c is fixed to the second case 140c by the swaging pins CP10c and CP40c, as illustrated in FIGS. 10, 13, and 14.

When the liquid container 100c is completely assembled, the first case 130c is fixed to the second case 140c by the swaging pins CP10c and CP40c of the fixing member 120c, as illustrated in FIGS. 10 and 14.

When the liquid container 100c is completely assembled, the swaging pins CP10c and CP40c are viewable from the outside via the through-hole 138c of the first case 130c and the through-hole 148c of the second case 140c, as illustrated in FIG. 12.

When the liquid in the bag 110 is fully consumed, a user needs to perform the following steps, including a step of replacing the empty bag 110 and the fixing member 120c with new ones, in order to assemble the liquid container 100c.

First, the user inserts a cutting tool into the outer shell 100Sc via the through-hole 138c of the first case 130c or via the through-hole 148c of the second case 140c and then cuts off the swaging pins CP10c and CP40c, as illustrated in FIG. 12. Then, he/she removes the swaging pins CP10c and CP40c from the outer shell 100Sc and separates the first case 130c from the second case 140c.

The above configuration in the third embodiment enables the user to easily break and remove the swaging pins CP10c and CP40c from the outside of the outer shell 100Sc via the through-hole 138c or 148c in the outer shell 100Sc.

After having separated the first case 130c from the second case 140c, the user replaces the fixing member 120c and the bag 110 with new ones and attaches the new fixing member 120c and bag 110 to the first case 130c or the second case 140c. Then, he/she joins the first case 130c to the second case 140c with the fixing member 120c and the bag 110 therebetween.

The user passes the swaging pin CP10c of the fixing member 120c through both the through-hole CPH10c of the first case 130c and the through-hole CPH10cB of the second case 140c while aligning the through-holes CPH10c and CPH10cB with each other. Likewise, the user passes the swaging pin CP40c of the fixing member 120c through both the through-hole CPH40c of the first case 130c and the through-hole CPH40cB of the second case 140c while aligning the through-holes CPH40c and CPH40cB with each other. The remaining steps are substantially the same as those of assembling the liquid container 100c for the first time.

The configuration in the third embodiment enables the user to easily reassemble the liquid container 100c simply by replacing the bag 110 and the fixing member 120c equipped with the swaging pins CP10c and CP40c with new ones.

Herein, the combination of the first case 130c and the second case 140c in the third embodiment may correspond to a pair of members.

### D. Modifications

### D1. First Modification

(1) In the foregoing first embodiment, twelve projections (CP10a to CP60a and CP10aB to CP60aB) are formed in the lid 150a as swaging pins, as illustrated in FIGS. 2 to 4. However, those swaging pins may be formed in the first case 130a or the second case 140a. Alternatively, the swaging pins may be formed in both the lid 150 and the first case 130a or both the lid 150 and the second case 140a to be fixed to each other.

(2) In the foregoing first embodiment, the lid 150a has twelve swaging pins (projections CP10a to CP60a and CP10aB to CP60aB), as illustrated in FIGS. 2 to 4. In the foregoing second embodiment, the liquid container 100b has two swaging pins (CP10b and CP40b), as illustrated in FIGS. 6 and 9. In the foregoing third embodiment, the fixing member 120c has two swaging pins (CP10c and CP40c), as illustrated in FIGS. 11 and 14 to 16. However, a liquid container may have one, three, four, five, seven, eight, or more swaging pins.

(3) In the foregoing embodiments, each of the outer shells 100Sa to 100Sc entirely covers the bag 110, as illustrated in FIGS. 1 and 5 to 10). However, an outer shell may partly expose a bag to the outside, in other words, may have only to surround the bag.

### D2. Second Modification

In the foregoing first embodiment, the lid 150a has twelve projections (CP10a to CP60a and CP10aB to CP60aB) as swaging pins, as illustrated in FIGS. 2 to 4. The lid 150a is fixed to the first case 130a by two of the projections CP10a to CP60a, as illustrated in FIGS. 1 and 3, and also fixed to the second case 140a by two of remaining ones of the projections CP10aB to CP60aB. However, a pair of members may be fixed to each other by all swaging pins provided in one or both of the pair of members.

### D3. Third Modification

In the foregoing second embodiment, the swaging pins CP10b and CP40b, by which the first case 130b is fixed to the second case 140b, are independent members, as illustrated in FIG. 6. However, the swaging pins may be integrated with one of a pair of members to be fixed to each other by these swaging pins, as illustrated in FIG. 2.

### D4. Furth Modifications

In the foregoing third embodiment, the fixing member 120c has two swaging pins (CP10c and CP40c), as illustrated in FIG. 11. However, the fixing member 120c has one, three, or more swaging pins. Alternatively, another member that is coupled to a bag and independent of a fixing member may have swaging pins.

### D5. Fifth Modification

In the foregoing second embodiment, the swaging pin CP40b is viewable from the outside via both the through-hole 136b of the first case 130b and the through-hole 156b of the lid 150b and via both the through-hole 148b of the second case 140b and the through-hole 158b of the lid 150b, as illustrated in FIGS. 6 and 8. In the foregoing third embodiment, the swaging pin CP40b is viewable from the outside via the through-hole 138c of the first case 130c and the through-hole 148c of the second case 140c, as illustrated in FIGS. 11 and 12.

However, an outer shell may have a through-hole via which swaging pins are not viewable from the outside but a user can access and break the swaging pins by using a special tool. Alternatively, the outer shell may have no through-holes via which a user can access swaging pins, as in the foregoing first embodiment.

### E. Other Modifications

The present disclosure is not limited to the foregoing embodiments and may be implemented in various aspects within its spirit. For example, the present disclosure may be implemented in the aspect that will be described below. The technical features in the foregoing embodiments which are equivalent to those in the aspect can be replaced with others or combined together as appropriate in order to address some or all of the disadvantages of the present disclosure or accomplish some or all the effects of the present disclosure. The technical features in the foregoing embodiments may be deleted as appropriate if they are not described as being essential herein.

(1) According to an aspect of the present disclosure, a liquid container includes: a bag that contains a liquid; and a pair of members configured to be reused when the liquid container is reassembled by replacing the bag used. The pair of members are fixed to each other by one or more swaging pins.

The above configuration enables a user to easily break swaging pins and detach a plurality of members from one another even when a liquid container has undergone temperature changes.

(2) In the liquid container of the aspect, at least one of the pair of members may be provided with the swaging pins configured to fix the pair of members to each other. The pair of members may be fixed to each other by one or more of swaging pins.

The above configuration enables a user to, when reusing a pair of members, fix these members to each other by one or more unused swaging pins. Therefore, the user can reuse the pair of members to reassemble a liquid container while maintaining the strength at which the pair of members are fixed to each other, regardless of how many times the pair of members have been reused. Moreover, since the number of times that the pair of members can be reused is related to the number of swaging pins to be used, the user can easily know how many times the pair of members can be reused, based on the configuration of the liquid container.

(3) In the liquid container of the aspect, the pair of members may be members independent of the swaging pins.

The above configuration enables a user to fix the pair of members to each other by using new swaging pins when a pair of members are reused. Therefore, the user can reuse the pair of members in order to reassemble a liquid container while maintaining t he strength at which the pair of members are fixed to each other, regardless of how many times the pair of members have been reused. This configuration enables the user to reuse the pair of members to each other, regardless of how many times swaging pins have been broken when the liquid container is reassembled. Since the user replaces swaging pins but reuses the pair of members when assembling the liquid container, the swaging pins are permitted to be damaged or deformed when the pair of members are detached from each other, but it is preferable for the pair of members not to be damaged or deformed. Consequently, the swaging pins and the pair of members have different roles and functions, thereby making it possible to easily design parts of the pair of members which receive the swaging pins.

(4) In the liquid container of the aspect, the pair of members may be members that form at least a portion of an outer shell surrounding the bag. This liquid container may further include a fixing member that fixes the bag to the outer shell. The fixing member may be provided with the swaging pins.

The above configuration enables a user to easily reassemble a liquid container simply by replacing a bag and a fixing member equipped with swaging pins with new ones.

(5) The liquid container of the aspect may further include an outer shell surrounding the bag. The outer shell may have a through-hole via which the swaging pins by which the pair of members are fixed to each other are viewable from an outside.

The above configuration enables a user to easily break and remove swaging pins from the outside of an outer shell via a through-hole.

The present disclosure can be implemented in various forms of liquid containers. Examples of such forms include: a method of manufacturing a liquid container; a computer program for realizing a method of controlling a liquid container; and a nonvolatile recording medium that stores the computer program.

What is claimed is:

1. A liquid container comprising:
a bag that contains a liquid; and
a pair of members configured to be reused when the liquid container is reassembled by replacing the bag used,
the pair of members being fixed to each other by one or more swaging pins.

2. The liquid container according to claim 1, wherein
at least one of the pair of members is provided with the swaging pins configured to fix the pair of members to each other, and
the pair of members are fixed to each other by one or more of the swaging pins.

3. The liquid container according to claim 1, wherein
the pair of members are members independent of the swaging pins.

4. The liquid container according to claim 1, wherein
the pair of members are members that form at least a portion of an outer shell surrounding the bag,
the liquid container further comprises a fixing member that fixes the bag to the outer shell, and
the fixing member is provided with the swaging pins.

5. The liquid container according to claim 1, further comprising an outer shell surrounding the bag, wherein
the outer shell has a through-hole via which the swaging pins by which the pair of members are fixed to each other are viewable from an outside.
